(19) United States
(12) Patent Application Publication
(10) Pub. No.: US 2016/0152014 A1
(43) Pub. Date: Jun. 2, 2016

(54) TRANSPARENT CONDUCTIVE SHEET AND TOUCH PANEL USING TRANSPARENT CONDUCTIVE SHEET

(71) Applicant: NISSHA PRINTING CO., LTD., Kyoto (JP)

(72) Inventors: Masashi MATSUMOTO, Kyoto (JP); Katsumi TOKUNO, Kyoto (JP); Yasuji KUSUDA, Kyoto (JP); Koji OKAMOTO, Kyoto (JP)

(21) Appl. No.: 14/906,903

(22) PCT Filed: Jul. 18, 2014
(86) PCT No.: PCT/JP2014/069165

§ 371 Date: Jan. 22, 2016

(30) Foreign Application Priority Data
Aug. 1, 2013 (JP) 2013-160846

(51) Int. Cl. B32B 27/18; G06F 3/041

(52) U.S. Cl. CPC B32B 27/18; G06F 3/041; B32B 2307/412; B32B 2457/208; B32B 2307/202

(57) ABSTRACT

Provided is a transparent conductive sheet in which a silver nanowire is resistant to oxidation even if the silver nanowire is exposed to visible light. The transparent conductive sheet includes a base sheet, a silver nanowire holding layer laminated on the base sheet, a sacrificial reagent added into the silver nanowire holding layer, and a silver nanowire laminated on a surface of the silver nanowire holding layer.

### PRIORITY

This is a National Stage Application under 35 U.S.C. §365 of International Application PCT/JP2014/069165, with an international filing date of Jul. 18, 2014, which claims priority to Japanese Patent Application No. 2013-160846 filed on Aug. 1, 2013. The entire disclosures of International Application PCT/JP2014/069165 and Japanese Patent Application No. 2013-160846 are hereby incorporated herein by reference.

### TECHNICAL FIELD

Certain implementations of the present invention relate to a transparent conductive sheet used as a transparent electrode or the like, and particularly to a transparent conductive sheet including a transparent conductive nanowire.

### BACKGROUND

A transparent conductive film including a conductive compound thin film laminated on a transparent base material is widely used in electric and electronic fields for applications utilizing its conductive property, as transparent electrodes of a flat display such as a liquid crystal display or an EL display, and a touch panel, for example. As the transparent conductive film described above, there is well known a transparent conductive film produced by depositing tin oxide (SnO₂), indium tin oxide (ITO), zinc oxide (ZnO), or the like on at least one of surfaces of the transparent base material by a dry process such as a vacuum vapor deposition method, a sputtering method, or an ion plating method.

In addition, other than the above-mentioned dry process, there is proposed a transparent conductive film produced by a wet process utilizing a conductive high polymer, a CNT, or a network structure of metal fine particles such as a metal nanowire.

Among them, recent years, the metal nanowire has been studied as a conductive material that is transparent in a visible light region. The metal nanowire is small and has high optical transparency in the visible light region, and therefore, its application as a transparent conductive film as a substitute of the ITO is expected. As the metal nanowire described above, gold nanowire, silver nanowire, copper nanowire, and the like are generally known.

However, when the silver nanowire is used in real condition, there is a problem that conductivity is deteriorated due to oxidation of silver. A structure in which an antioxidant is added or an overcoat layer is disposed may prevent deterioration of conductivity. However, even if the antioxidant is added or the overcoat layer is disposed, if the silver nanowire is exposed to visible light, there occurs a problem that the silver nanowire is oxidized so that a resistance of the transparent conductive sheet is increased.

### SUMMARY

Accordingly, it is an object certain implementations of the present invention to provide a transparent conductive sheet in which the silver nanowire is resistant to oxidation even if the silver nanowire is exposed to visible light.

In order to achieve the above-mentioned object, certain implementations of the present invention have the following structures.

A first aspect provides a transparent conductive sheet including a base sheet, a silver nanowire holding layer laminated on the base sheet, a sacrificial reagent added to the silver nanowire holding layer, and a silver nanowire laminated on a surface of the silver nanowire holding layer.

A second aspect provides a transparent conductive sheet including a base sheet, a silver nanowire holding layer laminated on the base sheet, a silver nanowire laminated on a surface of the silver nanowire holding layer, an overcoat layer laminated on the silver nanowire, and a sacrificial reagent added to the overcoat layer.

A third aspect provides a transparent conductive sheet including a base sheet, a silver nanowire holding layer laminated on the base sheet, a silver nanowire laminated on a surface of the silver nanowire holding layer, an overcoat layer laminated on the silver nanowire, and a sacrificial reagent added to the silver nanowire holding layer.

A fourth aspect provides the transparent conductive sheet in which the sacrificial reagent is added at a ratio of 0.01% to 10% with respect to resin composing the silver nanowire holding layer.

A fifth aspect provides the transparent conductive sheet in which the sacrificial reagent is added at a ratio of 0.01% to 10% with respect to resin composing the overcoat layer.

A sixth aspect provides the transparent conductive sheet in which the silver nanowire has a diameter of 5 to 500 nm and a length of 500 to 50,000 nm.

A seventh aspect provides a transparent conductive sheet in which the silver nanowire is plated with a metal other than silver.

An eighth aspect provides a touch panel using the transparent conductive sheet described above.

The transparent conductive sheet of certain implementations of the present invention can suppress an increase of a resistance of the transparent conductive sheet even if the silver nanowire is exposed to visible light for a long period of time.

### BRIEF DESCRIPTION OF THE DRAWINGS

FIG. 1 is a cross-sectional view of a transparent conductive sheet.

FIG. 2 is a cross-sectional view of the transparent conductive sheet.

FIG. 3 is a perspective view of a touch panel.

FIG. 4 is an A-A′ cross-sectional view of FIG. 2.

FIG. 5 is a B-B′ cross-sectional view of FIG. 3.

### DETAILED DESCRIPTION

Now, implementations of the present invention are described in more detail with reference to the drawings. Note that sizes, materials, shapes, and relative positions thereof, and the like of sections and parts described in examples of the present invention are merely examples for description and should not be interpreted to limit the scope of the invention unless otherwise noted.

As illustrated in FIG. 1, a transparent conductive sheet 1 has a structure in which a base sheet 2, a silver nanowire holding layer 3, a silver nanowire 4, and an overcoat layer 5 are laminated in this order. Further, a sacrificial reagent is added to at least one of the silver nanowire holding layer 3 and the overcoat layer 5.

In addition, the silver nanowire holding layer 3, the silver nanowire 4, and the overcoat layer 5 can be formed by the same method as a conventional method unless otherwise noted. As examples of the conventional method, there are coating methods such as a gravure coating method, a roll coating method, and a comma coating method, and printing methods such as a gravure printing method and a screen printing method. The above-mentioned members are described below.

[Base Sheet]

The base sheet is not particularly limited as long as it is a sheet-like or a film-like member. For instance, there can be named glass such as quartz glass, non-alkali glass, crystallization transparent glass, or Pyrex (registered trademark), ceramic such as alumina, metal such as iron, aluminum, or copper, thermoplastic resin such as polyethylene resin, polyester resin, cellulose resin, vinyl alcohol resin, vinyl chloride resin, cycloolefin resin, polycarbonate resin, acrylic resin, or ABS resin, light curing resin, thermosetting resin, and the like. When transparency is important, it is preferred that a total light transmittance thereof is 80% or higher, and glass, polyethylene resin, polyester resin, polycarbonate resin, acrylic resin, cellulose resin, and the like can be named, for example. A thickness of the above-mentioned base material is 10 μm to 10 mm.

[Silver Nanowire Holding Layer]

The silver nanowire holding layer is not particularly limited as long as it can hold the silver nanowire on the base sheet. As a material composing the silver nanowire holding layer, binder resin and photosensitive resin can be named. Note that it is preferred to use photosensitive resin in view that a thickness of the silver nanowire holding layer can be reduced.

As the binder resin, there can be named thermoplastic resin such as acrylic resin, polyester resin, polyurethane resin, nitrocellulose resin, chlorinated polyethylene resin, chlorinated polypropylene resin, or polyvinyl chloride, and thermosetting resin such as melamine acrylate resin, urethane acrylate resin, epoxy resin, or polyimide resin.

As the photosensitive resin, there can be named thermoplastic resin such as acrylic resin, polyester resin, polyurethane resin, nitrocellulose resin, chlorinated polyethylene resin, chlorinated polypropylene resin, polyvinyl chloride, or the like, and thermosetting resin such as melamine acrylate resin, urethane acrylate resin, epoxy resin, polyimide resin, or the like.

[Silver Nanowire]The silver nanowire is made of silver. Note that the silver nanowires are intertwined and contact with each other so that the entire silver nanowires become conductive. As to a shape of the silver nanowire, it is preferred that a ratio between short axis length and a long axis length (herein after referred to as an aspect) be 10 to 10,000. If the aspect ratio is 10 or smaller, the transmittance is lowered. If the aspect ratio is larger than 10,000, physical strength and conductivity are lowered.

Further, the short axis length of the silver nanowire is preferred to be 5 to 500 nm, and is more preferred to be 5 to 100 nm. If the short axis length is larger than 500 nm, transmittance of the transparent conductive sheet is lowered. In addition, if the short axis length is smaller than 5 nm, the silver nanowires can hardly contact with each other, and hence conductivity of the transparent conductive sheet is lowered.

The long axis length is preferred to be 500 to 50,000 nm, and is more preferred to be 10,000 to 40,000 nm. If the long axis length is smaller than 500 nm, conductivity of the transparent conductive sheet is lowered. If the long axis length is larger than 50,000 nm, the transmittance is lowered.

Note that it is preferred that the silver nanowire be plated with metal other than silver. By plating with metal other than silver, oxidation of the silver nanowire can be suppressed when the silver nanowire is exposed to visible light.

[Overcoat Layer]

The overcoat layer is not particularly limited as long as it can protect the silver nanowire from physical or chemical stimulation. As a material composing the overcoat layer, binder resin or photosensitive resin can be named. Further, as a material composing the overcoat layer, it is possible to use thermoplastic resin such as polyester resin, cellulose resin, vinyl alcohol resin, vinyl resin, cycloolefin resin, polycarbonate resin, acrylic resin, urethane resin, epoxy resin, or ABS resin, light curing resin, thermosetting resin, or the like, which is a known coating material.

[Sacrificial Reagent]

The sacrificial reagent is a material for suppressing oxidation of the silver nanowire due to exposure to visible light. Note that the sacrificial reagent is added to at least one of layers adjacent to the silver nanowire (the silver nanowire holding layer and the overcoat layer). When the sacrificial reagent is added to the layer, the sacrificial reagent is excited by visible light, and the exited sacrificial reagent supplies electrodes to the silver nanowire. Then, oxidation of the silver nanowire due to exposure to visible light, namely oxidation of the silver nanowire due to plasmon resonance can be suppressed. As a result, it is possible to suppress an increase of a resistance of the transparent conductive sheet even if the transparent conductive sheet is exposed to visible light for a long period of time.

As the sacrificial reagent, there can be named molecules having an aldehyde group, a saccharide having an aldehyde group, an alcohol, and the like.

As molecules having an aldehyde group, there can be named formaldehyde, acetaldehyde, paraformaldehyde, propionaldehyde, n-butyraldehyde, caproaldehyde, allylaldehyde, benzaldehyde, crotonaldehyde, acrolein, phenylacetaldehyde, cinnamaldehyde, o-Tolualdehyde, and salicylaldehyde.

As the saccharide having an aldehyde group, there can be named aldose such as glucose, xylose, galactose, fructose, maltose, and lactose.

As the alcohol, there can be named methanol, ethanol, 1-propanol, 2-propanol, and butanol.

Note that a ratio of the added sacrificial reagent is 0.01% to 10% with respect to the resin composing the silver nanowire holding layer or the overcoat layer. If the ratio is higher than 10%, the silver nanowire is apt to be deteriorated by high temperature test or high temperature and high humidity test. In addition, if the ratio is lower than 0.01%, effective result cannot be obtained.

Next, a transparent conductive sheet of a second embodiment is described.

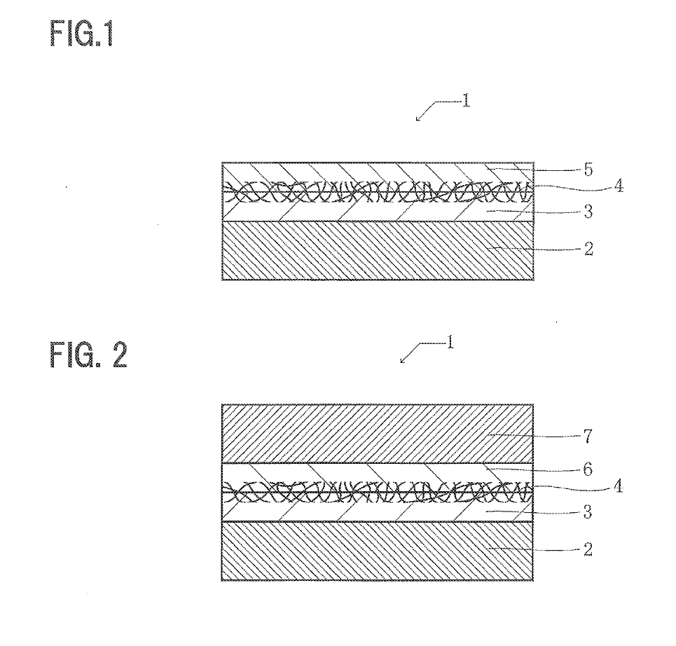

As illustrated in FIG. 2, the transparent conductive sheet has a structure in which the base sheet 2, the silver nanowire holding layer 3, the silver nanowire 4, an adhesive layer 6, and a base material 7 are laminated in this order. The structures of the base sheet 2, the silver nanowire holding layer 3, the silver nanowire 4, and the sacrificial reagent, and the method of forming the transparent conductive sheet 1 are the same as those of the first embodiment, and hence description thereof is omitted.

[Adhesive Layer]

A material of the adhesive layer is not particularly limited as long as it protects the silver nanowire from oxygen in the air and glues the base material to the silver nanowire. As a material composing the adhesive layer, there can be named thermoplastic resin such as acrylic resin, polyester resin, polyurethane resin, nitrocellulose resin, chlorinated polyethylene resin, chlorinated polypropylene resin, polyvinyl chloride resin, and the like, and thermosetting resin such as melamine acrylate resin, urethane acrylate resin, epoxy resin, polyimide resin, and the like.

Note that a sacrificial reagent may be added to the adhesive layer at a ratio of 0.01 to 10% with respect to resin composing the adhesive layer.

[Base Material]

The base material is not particularly limited as long as it protects the transparent conductive sheet from external damage or the like. As a material composing the base material, there can be named glass such as quartz glass, non-alkali glass, crystallization transparent glass, Pyrex (registered trademark) glass, or sapphire glass, acrylic resin such as polycarbonate or polymethyl methacrylate, vinyl chloride resin such as polyvinyl chloride, vinyl chloride copolymer, and thermoplastic resin such as polyarylate, polysulfone, polyethersulfone, polyimide, PET, PEN, fluorocarbon polymer, phenoxy resin, polyolefin resin, nylon, styrene resin, ABS resin, or cellulose resin.

[Touch Panel]

In the following description, a touch panel manufactured by using the above-mentioned transparent conductive sheet is described.

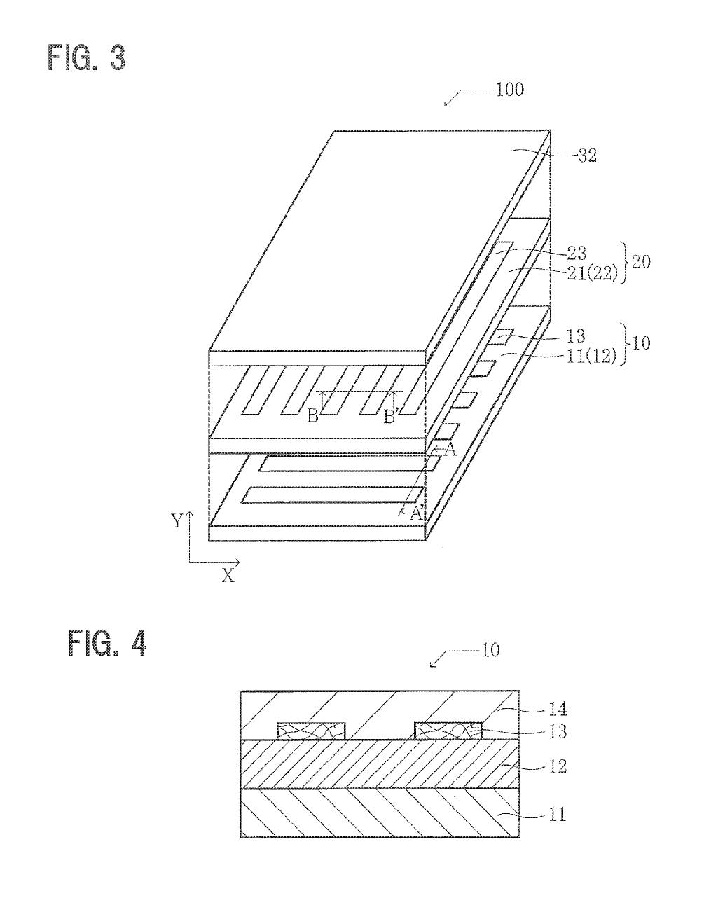

As illustrated in FIG. 3, a touch panel 100 has a structure in which two transparent conductive sheets 10 and 20 are glued to each other. Note that an overcoat layer 32 is laminated on the transparent conductive sheet 20.

As illustrated in FIG. 4, the transparent conductive sheet 10 has a structure in which a silver nanowire holding layer 12, a silver nanowire 13, and an adhesive layer 14 are laminated in this order on a base sheet 11. Note that the sacrificial reagent is added to at least one of the silver nanowire holding layer 12 and the adhesive layer 14 at a ratio of 0.01% to 10% with respect to resin composing the layer.

In addition, as illustrated in FIG. 3, a plurality of silver nanowires 13 are arranged in a Y axis direction so as to form Y electrodes in the touch panel 100.

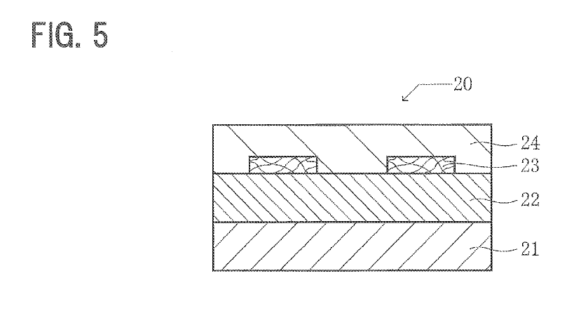

As illustrated in FIG. 5, the transparent conductive sheet 20 has a structure in which a silver nanowire holding layer 22, a silver nanowire 23, and an adhesive layer 24 are laminated in this order on the base sheet 21. The sacrificial reagent is added to at least one of the silver nanowire holding layer 22 and the adhesive layer 24 at a ratio of 0.01% to 10% with respect to resin composing the layer. In addition, as illustrated in FIG. 3, a plurality of silver nanowires 23 are arranged in an X axis direction so as to form X electrodes in the touch panel 100.

In this way, the silver nanowires 13 constituting the Y electrodes are sandwiched between the silver nanowire holding layer 12 and the adhesive layer 14, and the sacrificial reagent is added to at least one of the silver nanowire holding layer 12 and the adhesive layer 14. The same is true for the silver nanowires 23 constituting the X electrodes. Accordingly, even if the touch panel 100 is exposed to visible light for a long period of time, the silver nanowires 14 and 24 are resistant to oxidation. As a result, even if the touch panel 100 is exposed to visible light for a long period of time, a resistance thereof is not easily increased.

1. A transparent conductive sheet comprising:
a base sheet;
a silver nanowire holding layer laminated on the base sheet;
a sacrificial reagent added to the silver nanowire holding layer; and
a silver nanowire laminated on a surface of the silver nanowire holding layer.

2. A transparent conductive sheet comprising:
a base sheet;
a silver nanowire holding layer laminated on the base sheet;
a silver nanowire laminated on a surface of the silver nanowire holding layer;
an overcoat layer laminated on the silver nanowire; and
a sacrificial reagent added to the overcoat layer.

3. A transparent conductive sheet comprising:
a base sheet;
a silver nanowire holding layer laminated on the base sheet;
a silver nanowire laminated on a surface of the silver nanowire holding layer;
an overcoat layer laminated on the silver nanowire; and
a sacrificial reagent added to the silver nanowire holding layer.

4. The transparent conductive sheet according to claim 1, wherein the sacrificial reagent is added at a ratio of 0.01% to 10% with respect to resin composing the silver nanowire holding layer.

5. The transparent conductive sheet according to claim 2, wherein the sacrificial reagent is added at a ratio of 0.01% to 10% with respect to resin composing the overcoat layer.

6. The transparent conductive sheet according to claim 1, wherein the silver nanowire has a diameter of 5 to 500 nm and a length of 500 to 50,000 nm.

7. The transparent conductive sheet according to claim 1, wherein the silver nanowire is plated with a metal other than silver.

8. A touch panel using the transparent conductive sheet according to claim 1.

9. The transparent conductive sheet according to claim 3, wherein the sacrificial reagent is added at a ratio of 0.01% to 10% with respect to resin composing the silver nanowire holding layer.

10. The transparent conductive sheet according to claim 2, wherein the silver nanowire has a diameter of 5 to 500 nm and a length of 500 to 50,000 nm.

11. The transparent conductive sheet according to claim 3, wherein the silver nanowire has a diameter of 5 to 500 nm and a length of 500 to 50,000 nm.

12. The transparent conductive sheet according to claim 2, wherein the silver nanowire is plated with a metal other than silver.

13. The transparent conductive sheet according to claim 3, wherein the silver nanowire is plated with a metal other than silver.

14. A touch panel using the transparent conductive sheet according to claim 2.

15. A touch panel using the transparent conductive sheet according to claim 3.
